(19) United States
(12) Patent Application Publication
(10) Pub. No.: US 2023/0411664 A1
(43) Pub. Date: Dec. 21, 2023

(54) FUEL CELL DEVICE

(71) Applicant: EKPO Fuel Cell Technologies GmbH, Dettingen (DE)

(72) Inventors: Manuel MORCOS, Tübingen (DE); Kai WAHL, Metzingen (DE); Gerhard SCHULLER, Reutlingen (DE); Fabian MÖNCH, Stuttgart (DE); Jürgen KRAFT, Metzingen (DE)

(73) Assignee: EKPO Fuel Cell Technologies GmbH, Dettingen (DE)

(21) Appl. No.: 18/459,686

(22) Filed: Sep. 1, 2023

Related U.S. Application Data
(63) Continuation of application No. PCT/EP2022/055403, filed on Mar. 3, 2022.

(30) Foreign Application Priority Data
Mar. 5, 2021 (DE) 102021202175.1

(51) Int. Cl. H01M 8/242; H01M 8/2475

(52) U.S. Cl. CPC H01M 8/242; H01M 8/2475

(57) ABSTRACT

In order to provide a fuel cell device which is easy and cost-effective to manufacture and preferably has improved durability, it is proposed according to the invention that the fuel cell device comprises the following: -a fuel cell stack unit; -a supporting frame, in particular a housing, in which the fuel cell stack unit is arranged, -a bearing device, by means of which the fuel cell stack unit is mounted in the supporting frame, in particular in the housing, wherein the fuel cell device comprises a fixed bearing device and a floating bearing device, wherein the floating bearing device comprises one or more floating bearing units.

### CROSS-REFERENCE TO RELATED APPLICATIONS

This application is a continuation of International Application No. PCT/EP2022/055403 filed on Mar. 3, 2022, and claims the benefit of German Application No. 10 2021 202 175.1 filed on Mar. 5, 2021, all of which are incorporated herein by reference in their entirety and for all purposes.

### FIELD OF DISCLOSURE AND BACKGROUND

The present invention relates to a fuel cell device.

### SUMMARY OF THE INVENTION

The object of the present invention is to provide a fuel cell device which is easy and cost-effective to manufacture and preferably has improved durability.

This object is achieved by a fuel cell device having the features of claim 1.

The fuel cell device preferably comprises the following:
a fuel cell stack unit;
a supporting frame, in particular a housing, in which the fuel cell stack unit is arranged,
a bearing device, by means of which the fuel cell stack unit is mounted in the supporting frame, in particular in the housing,

wherein the fuel cell device comprises a fixed bearing device and a floating bearing device,

wherein the floating bearing device comprises one or more floating bearing units.

The floating bearing device comprises, for example, two or more than two floating bearing units.

The fuel cell stack unit preferably comprises a fuel cell stack.

The fixed bearing device and the floating bearing device are preferably arranged on sides of the fuel cell stack of the fuel cell stack unit facing away from one another.

The fuel cell stack preferably comprises a plurality of fuel cell elements arranged in a stacking direction. The fuel cell elements are in particular plate-shaped units which have different components for the electrochemical conversion of fuel, for conducting power and for conducting fluid.

The fuel cell stack unit of the fuel cell device preferably comprises two end plates, wherein the fuel cell stack of the fuel cell stack unit is preferably clamped between the two end plates by means of a clamping device, in particular by means of a plurality of clamping elements of the clamping device.

The fixed bearing device and the floating bearing device are preferably arranged on end regions of the fuel cell stack unit facing away from one another.

For example, it is conceivable for the fuel cell stack unit to comprise an upper end plate and a lower end plate.

The upper end plate and the lower end plate are preferably arranged on end regions of the fuel cell stack unit facing away from one another.

In an operating state of the fuel cell device, the upper end plate is preferably arranged on an upper end region of the fuel cell stack unit in the direction of gravity, wherein the lower end plate is preferably arranged on a lower end region of the fuel cell stack unit in the direction of gravity.

The fuel cell stack unit preferably also comprises a pressure distributor plate.

It may also be advantageous if the fuel cell stack unit comprises a pressure equalization device.

A height of the fuel cell stack taken parallel to the stacking direction of the fuel cell stack is in particular subject to fluctuations, for example due to thermal expansion during operation of the fuel cell device and/or due to a setting behavior of the fuel cell elements over a service life of the fuel cell device.

The pressure equalization device is used in particular to equalize changing compressive forces which can act on the fuel cell stack due to the changing height of the fuel cell stack, in particular for equalizing pressure forces acting in parallel with the stacking direction.

Preferably, on the one hand, the occurrence of excessively high pressure forces can be prevented with the pressure equalization device, wherein preferably, on the other hand, excessively low pressure forces could be prevented, which would lead to a leak of the fuel cell stack, since the fuel cell elements are not pressed against one another with sufficient pressure.

It may be advantageous if the pressure equalization device is arranged between the pressure distributor plate and an end plate of the fuel cell stack unit, for example between the pressure distributor plate and the upper end plate of the fuel cell stack unit.

Preferably, the fuel cell stack is arranged directly between the lower end plate and the pressure distributor plate.

Alternatively, it is conceivable for the pressure equalization device to be arranged between the pressure distributor plate and the lower end plate of the fuel cell stack unit, wherein the fuel cell stack is in particular arranged directly between the upper end plate and the pressure distributor plate.

The pressure equalization device preferably comprises a plurality of spring elements, for example a plurality of disk spring elements.

The fuel cell stack unit preferably comprises a clamping device by means of which the fuel cell stack of the fuel cell stack unit is clamped between two end plates of the fuel cell stack unit.

The clamping device preferably comprises a plurality of clamping elements, for example so-called “tie rods”.

It may be advantageous if the clamping elements of the clamping device are arranged on the end plates of the fuel cell stack unit such that the end plates of the fuel cell stack unit are pulled toward one another and/or that a tensile force acts on the end plates of the fuel cell stack unit which pulls the end plates toward one another.

The supporting frame preferably comprises an upper supporting frame element and a lower supporting frame element.

The upper supporting frame element and the lower supporting frame element are preferably fixed relative to one another.

In particular, a position of the upper supporting frame element relative to a position of the lower supporting frame element is fixed.

The supporting frame is preferably a housing of the fuel cell device.

A particular supporting frame element is preferably a housing cover of the housing.

For example, it is conceivable for the upper supporting frame element to be an upper housing cover and for the lower supporting frame element to be a lower housing cover.

The housing preferably comprises an upper housing cover and a lower housing cover.

The upper housing cover and the lower housing cover of the housing are preferably arranged on end regions of the housing of the fuel cell device which face away from one another.

It may be advantageous if the housing also comprises a housing shell which preferably connects the upper housing cover and the lower housing cover to one another.

An interior of the housing of the fuel cell device is preferably delimited by the upper housing cover, the housing shell and the lower housing cover.

In an operating state of the fuel cell device, the upper supporting frame element, in particular the upper housing cover, is preferably arranged on an upper end region of the fuel cell device in the direction of gravity, wherein the lower supporting frame element, in particular the lower housing cover, is preferably arranged on a lower end region of the fuel cell device in the direction of gravity.

The housing of the fuel cell device preferably comprises a plurality of mounting elements which are fixed to the housing on an outer side of the housing.

The fuel cell device can be fixed, for example, to a supporting structure of a vehicle by means of the mounting elements.

For example, it is conceivable for the housing to comprise a plurality of, for example four, mounting elements which are fixed to the upper housing cover and/or to the lower housing cover of the housing.

In one embodiment of the fuel cell device, the floating bearing device is designed such that the fuel cell stack unit is mounted in the supporting frame, in particular in the housing, of the fuel cell device such that torsion of the fuel cell stack unit can be limited and/or substantially prevented.

If there is torsion of the fuel cell stack unit, in particular rotation of the upper end plate relative to the lower end plate can occur.

Such a rotation of the upper end plate relative to the lower end plate can cause the fuel cell elements of the fuel cell stack to slide on one another, which can lead to destruction of the fuel cell stack.

Preferably, the floating bearing device is designed such that a rotation of the upper end plate of the fuel cell stack unit relative to the lower end plate of the fuel cell stack unit can be limited and/or substantially prevented.

If the floating bearing device comprises a plurality of floating bearing units, torsion of the fuel cell stack unit is preferably limited and/or substantially prevented by the plurality of floating bearing units.

Alternatively, it is conceivable for the floating bearing device to comprise a single floating bearing unit which is designed such that torsion of the fuel cell stack unit can be limited and/or substantially prevented.

If the floating bearing device comprises a single floating bearing unit, the single floating bearing device is preferably designed such that an axial movement of the fuel cell stack unit relative to the supporting frame, in particular relative to the housing, is permitted.

A single floating bearing unit, by means of which torsion of the fuel cell stack unit can be limited and/or substantially prevented, comprises, for example, a CV joint bearing or a homokinetic joint or is formed thereby.

If the floating bearing device comprises only a single floating bearing unit, the single floating bearing unit is designed, for example, such that torsion of a first floating bearing element of the floating bearing unit is prevented and/or limited relative to a second floating bearing element of the floating bearing unit.

If the floating bearing device comprises only a single floating bearing unit, the single floating bearing unit is arranged substantially centrally on an end plate of the fuel cell stack unit.

In one embodiment of the fuel cell device, the fuel cell stack unit is fixedly mounted on one side in the supporting frame, in particular in the housing, of the fuel cell device by means of the fixed bearing device.

The fuel cell stack unit is preferably mounted on one of its end regions fixedly in the supporting frame, in particular in the housing, of the fuel cell device, for example on a supporting frame element of the supporting frame or on a housing cover of the housing.

In one embodiment of the fuel cell device, provision is made for a lower end plate of the fuel cell stack unit to be fixed to a supporting frame element, preferably to a housing cover, in particular to a lower supporting frame element, preferably to a lower housing cover.

For example, it is conceivable for the lower end plate of the fuel cell stack unit to be screwed to the lower supporting frame element and/or to the lower housing cover of the housing.

Alternatively, it is conceivable for the lower end plate of the fuel cell stack unit to be integrally connected to the lower supporting frame element and/or to the lower housing cover of the housing.

In an alternative embodiment of the fuel cell device, an upper end plate of the fuel cell stack unit is fixed to an upper supporting frame element, in particular to an upper housing cover of the housing.

The upper end plate is, for example, screwed as a single part to the upper supporting frame element, in particular to the upper housing cover of the housing, or alternatively thereto, is connected as a single part to the upper supporting frame element, in particular to the housing cover of the housing.

In one embodiment of the fuel cell device, the fuel cell stack unit is loosely mounted on one side in the supporting frame, in particular in the housing, of the fuel cell device by means of the floating bearing device.

The fuel cell stack unit is preferably loosely mounted on one of its end regions in the supporting frame, in particular in the housing, of the fuel cell device, for example on a housing cover of the housing.

In one embodiment of the fuel cell device, a particular floating bearing unit comprises two floating bearing elements in each case, wherein a first floating bearing element of the particular floating bearing unit is preferably fixed to the fuel cell stack unit, and wherein a second floating bearing element of the particular floating bearing unit is preferably fixed to the supporting frame, in particular to the housing, of the fuel cell device.

In one embodiment of the fuel cell device, a first floating bearing element of the particular floating bearing unit is fixed to an end plate of the fuel cell stack unit and/or a second floating bearing element of the particular floating bearing unit is fixed to a supporting frame element of the supporting frame, in particular to a housing cover of the housing, of the fuel cell device.

For example, it is conceivable for the first floating bearing element to be fixed to an upper end plate of the fuel cell stack unit, wherein the second floating bearing element is fixed to an upper supporting frame element of the supporting frame, in particular to an upper housing cover of the housing, of the fuel cell device.

Alternatively, it is conceivable for the first floating bearing element to be fixed to a lower end plate of the fuel cell stack unit, wherein the second floating bearing element is fixed to a lower supporting frame element of the supporting frame, in particular to a lower housing cover of the housing, of the fuel cell device.

In one embodiment of the fuel cell device, a floating bearing element of a floating bearing unit, which element is fixed to the supporting frame, in particular to the housing, is guided in a guide direction in a floating bearing element of the floating bearing unit, which element is fixed to the fuel cell stack unit, and/or a floating bearing element of a floating bearing unit, which element is fixed to the fuel cell stack unit, is guided in a guide direction in a floating bearing element of the floating bearing unit, which element is fixed to the supporting frame, in particular to the housing.

The guide direction preferably extends in parallel with the stacking direction of the fuel cell stack of the fuel cell stack unit.

For example, it is conceivable for all floating bearing elements fixed to the supporting frame, in particular to the housing, to be guided in floating bearing elements which are fixed to the fuel cell stack unit.

Alternatively, it is conceivable for all floating bearing elements fixed to the fuel cell stack unit to be guided in floating bearing elements which are fixed to the supporting frame, in particular to the housing.

It may also be advantageous if individual floating bearing elements fixed to the supporting frame, in particular to the housing, are guided in floating bearing elements which are fixed to the fuel cell stack unit, and if individual floating bearing elements fixed to the fuel cell stack unit are guided in floating bearing elements which are fixed to the supporting frame, in particular to the housing.

For example, it is conceivable for the floating bearing device to comprise two floating bearing units, wherein the floating bearing element of a first floating bearing unit, which element is fixed to the fuel cell stack unit, is guided in a floating bearing element fixed to the supporting frame, in particular to the housing, wherein the floating bearing element of a second floating bearing unit, which element is fixed to the supporting frame, in particular to the housing, is guided in a floating bearing element fixed to the fuel cell stack unit.

In one embodiment of the fuel cell device, the floating bearing element, which is fixed to the supporting frame, in particular to the housing, and is guided in the floating bearing element fixed to the fuel cell stack unit, can be moved in the guide direction relative to the floating bearing element fixed to the fuel cell stack unit, and/or the floating bearing element, which is fixed to the fuel cell stack unit and is guided in the floating bearing element fixed to the supporting frame, in particular to the housing, can be moved in the guide direction relative to the floating bearing element fixed to the supporting frame, in particular to the housing.

The floating bearing elements are designed in particular such that the floating bearing element, which is fixed to the supporting frame, in particular to the housing, and which is guided in the floating bearing element fixed to the fuel cell stack unit, can be moved in the guide direction relative to the floating bearing element fixed to the fuel cell stack unit.

Alternatively or additionally, the floating bearing elements are preferably designed such that the floating bearing element, which is fixed to the fuel cell stack unit and is guided in the floating bearing element fixed to the supporting frame, in particular to the housing, can be moved in the guide direction relative to the floating bearing element fixed to the supporting frame, in particular to the housing.

In one embodiment of the fuel cell device, the floating bearing elements are designed such that a movement of the floating bearing element, which is fixed to the supporting frame, in particular to the housing, and is guided in the floating bearing element fixed to the fuel cell stack unit, is limited and/or prevented in a direction extending transversely, preferably perpendicularly, to the guide direction, and/or the floating bearing elements are designed such that a movement of the floating bearing element, which is fixed to the fuel cell stack unit and is guided in the floating bearing element fixed to the supporting frame, in particular to the housing, is limited and/or prevented in a direction extending transversely, preferably perpendicularly, to the guide direction.

In one embodiment of the fuel cell device, a particular floating bearing unit comprises a floating bearing element which comprises a sleeve element, and the floating bearing unit further comprises a floating bearing element which comprises or forms a rod element, wherein the rod element is preferably arranged at least partially in the sleeve element.

The rod element preferably projects at least partially into the sleeve element, in particular into an opening of the sleeve element.

The floating bearing elements of a particular floating bearing unit are preferably designed to be substantially rotationally symmetrical.

The rod elements of the floating bearing elements of the two or more than two floating bearing units are preferably arranged substantially in parallel with one another.

In particular, the longitudinal axes of the rod elements of the floating bearing elements of the two or more than two floating bearing units are preferably arranged substantially in parallel with one another.

The fact that the longitudinal axes of the rod elements of the floating bearing elements of the two or more than two floating bearing units are arranged substantially in parallel with one another is preferably defined in the context of this description and the appended claims such that an angular deviation of the longitudinal axes of the rod elements is preferably at most approximately 20°, for example at most approximately 10°, and in particular at most approximately 5°.

In one embodiment of the fuel cell device, a particular floating bearing unit comprises a floating bearing element which comprises a compensating element that is arranged on, in particular fixed to, the floating bearing element of the floating bearing unit.

The compensating element is preferably fixed to a sleeve element of the floating bearing element.

For example, it is conceivable for the compensating element to be inserted into an opening of the sleeve element.

Preferably, the compensating element is arranged in a direction extending transversely, preferably perpendicularly, to a guide direction between a rod element of a first floating bearing element and a sleeve element of a second floating bearing element of a particular floating bearing unit.

It may be advantageous if the compensating element is a damping element, in particular a rubber element, for example a rubber ring.

A damping element designed as a rubber element preferably comprises a metal sliding surface on which a rod element can slide.

The damping element preferably dampens and/or limits a movement of the two floating bearing elements of a particular floating bearing unit relative to one another in a direction extending transversely, preferably perpendicularly, to a guide direction.

Alternatively, it is conceivable for the compensating element to be formed, for example, by a pivot bearing.

Angular compensation can preferably be made possible between the two floating bearing units of the floating bearing device by means of a compensating element which is formed by a pivot bearing.

In one embodiment of the fuel cell device, the floating bearing device comprises two or more than two floating bearing units, wherein floating bearing elements of a particular floating bearing unit are preferably arranged on the fuel cell stack unit such that a distance between the floating bearing units is maximum.

Floating bearing elements of the floating bearing units are in particular arranged on an end plate of the fuel cell stack unit such that a distance of the floating bearing elements from one another is maximum.

Preferably, a rotation of the upper end plate of the fuel cell stack unit relative to the lower end plate can be prevented or limited even better by maximizing a distance of the floating bearing units from one another.

In one embodiment of the fuel cell device, the floating bearing device comprises two floating bearing units, wherein floating bearing elements of the floating bearing units are arranged diagonally opposite one another on an end plate of the fuel cell stack unit.

In one embodiment of the fuel cell device, the floating bearing units of the floating bearing device comprise or form a linear guide.

Further preferred features and/or advantages of the invention form the subject matter of the following description and the drawings illustrating exemplary embodiments.

### BRIEF DESCRIPTION OF THE DRAWINGS

FIG. 1 shows a schematic perspective representation of an embodiment of a fuel cell device obliquely from below;

FIG. 2 shows a schematic perspective representation of the embodiment of the fuel cell device from FIG. 1 obliquely from above;

FIG. 3 shows a schematic perspective representation of the embodiment of a fuel cell device from FIG. 1 obliquely from above, wherein the fuel cell device is placed on the head;

FIG. 4 is a schematic plan view of the embodiment of a fuel cell device from FIG. 1 when viewing along the arrow 4 in FIG. 2;

FIG. 5 shows a schematic section through the embodiment of the fuel cell device from FIG. 1 along the line V-V in FIG. 4;

FIG. 6 shows an enlarged representation of the region VI in FIG. 5;

FIG. 7 is a schematic side view of the embodiment of a fuel cell device from FIG. 1 when viewing along the arrow 7 in FIG. 1;

FIG. 8 shows a schematic section through the embodiment of the fuel cell device from FIG. 1 along the line VIII-VIII in FIG. 7;

FIG. 9 is s a schematic exploded view of the embodiment of a fuel cell device from FIG. 1; and

FIG. 10 shows a representation of a further embodiment of a fuel cell device, which representation corresponds to the representation in FIG. 6.

The same or functionally equivalent elements are provided with the same reference signs in all figures.

### DETAILED DESCRIPTION OF THE DRAWINGS

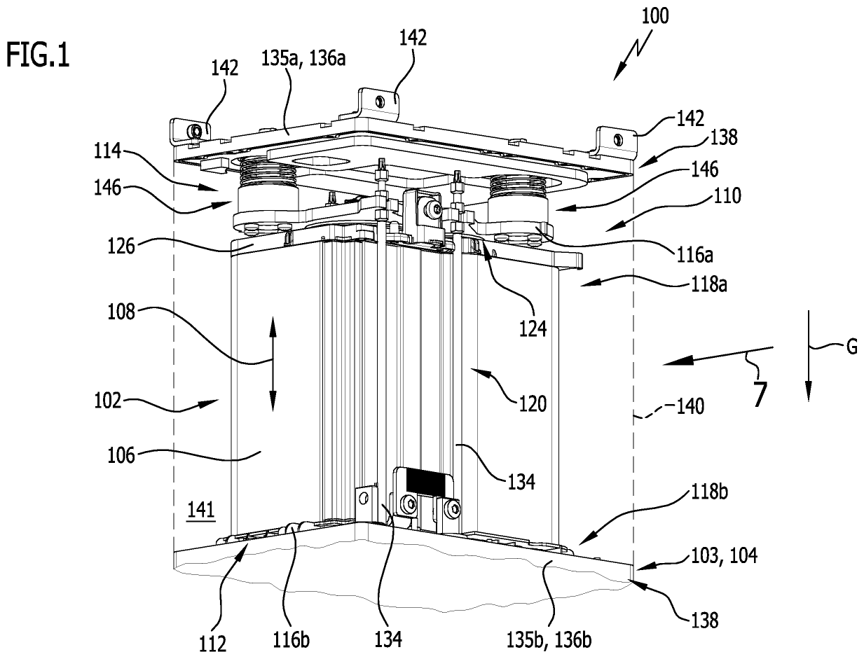

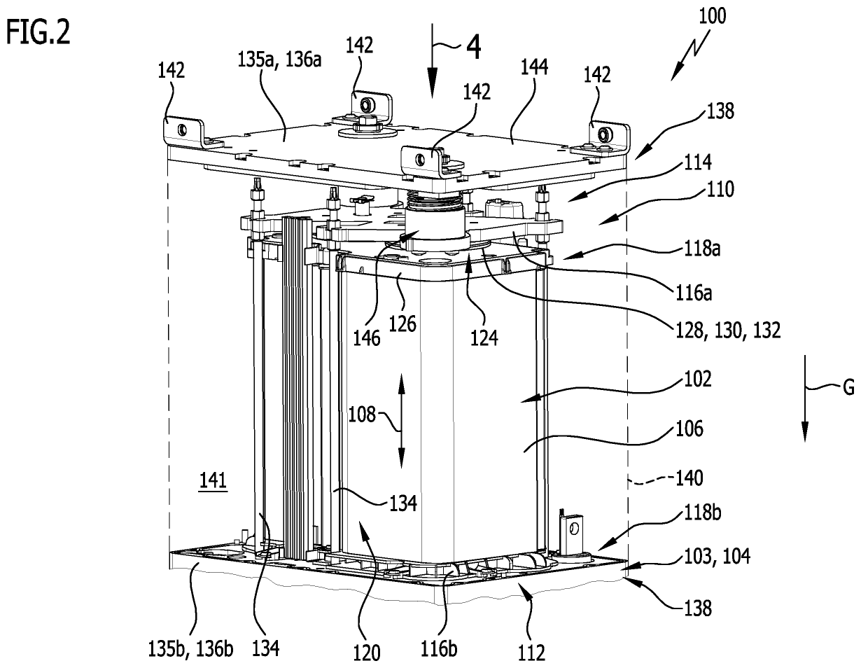

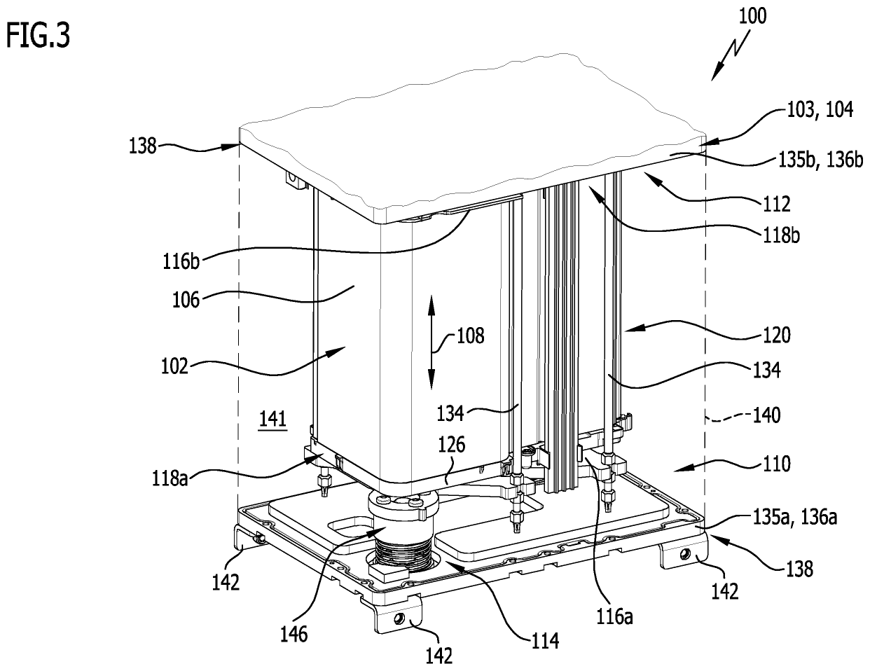

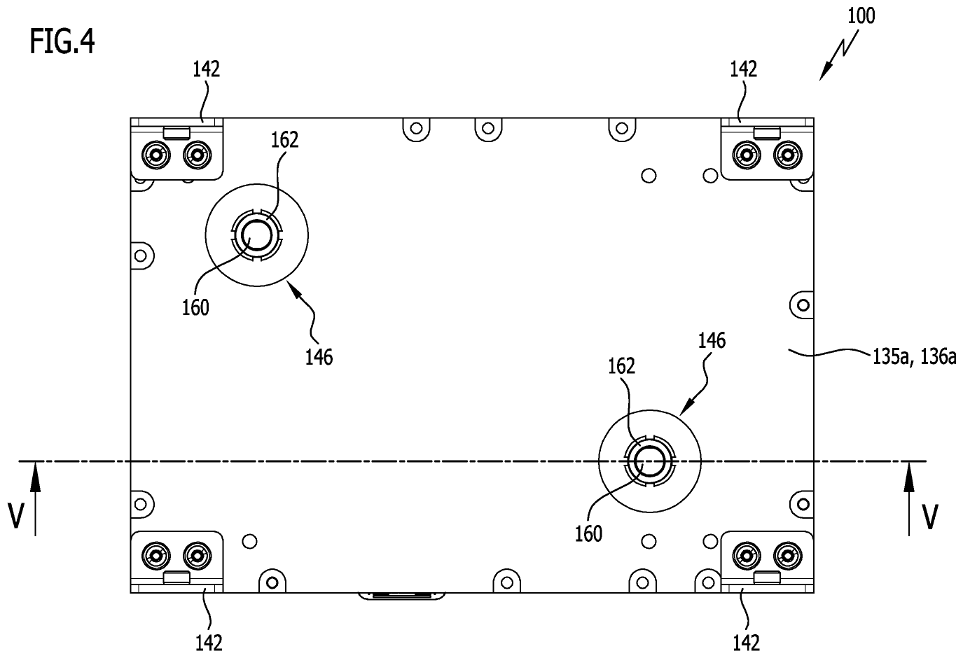

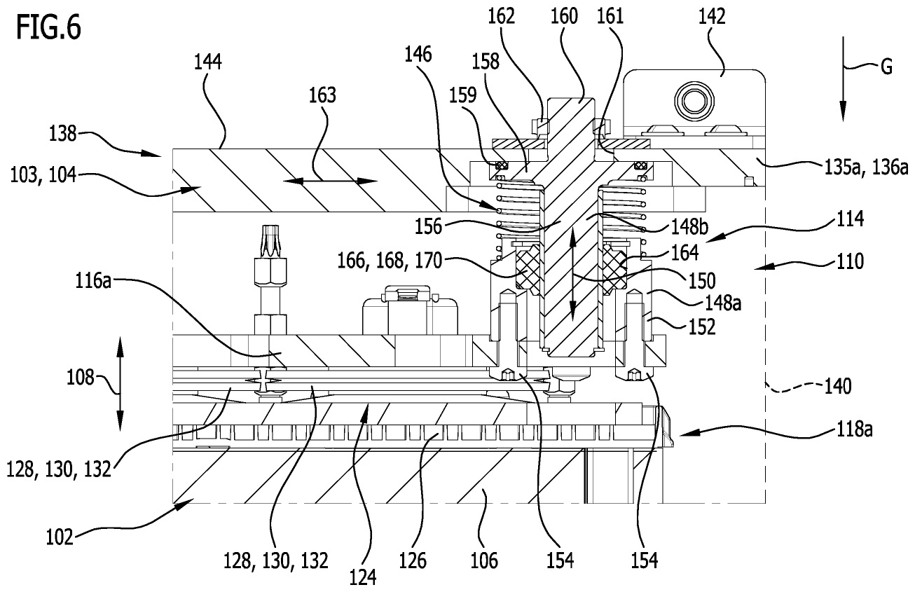

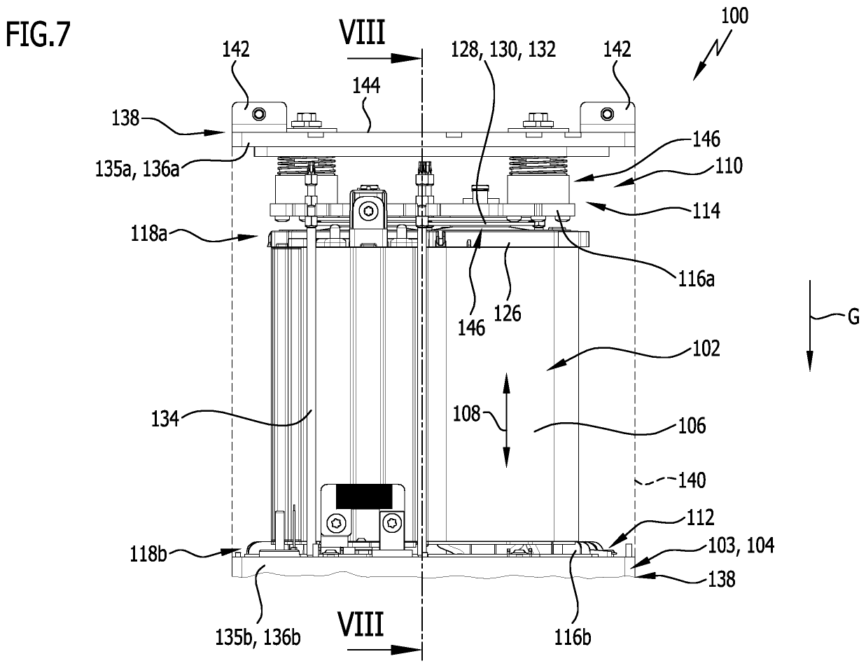

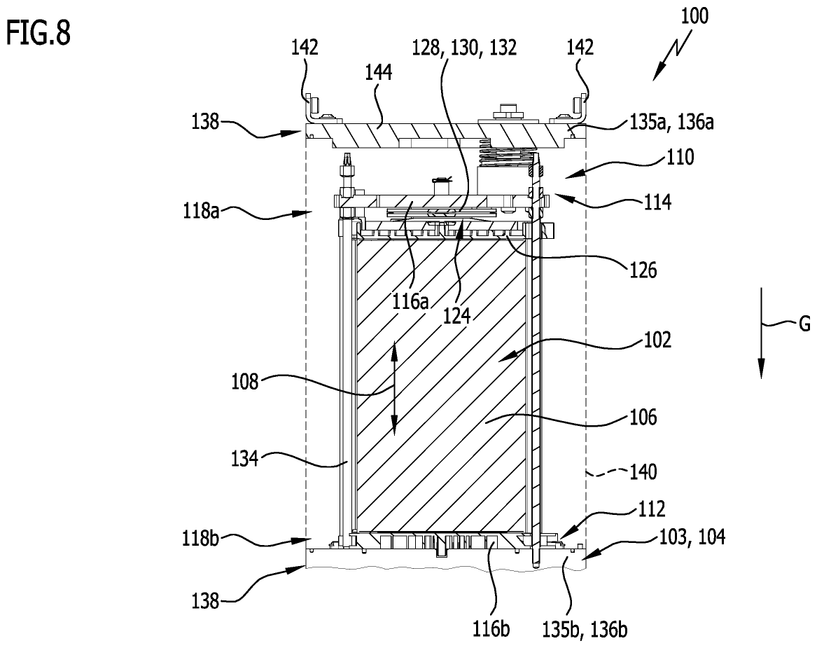

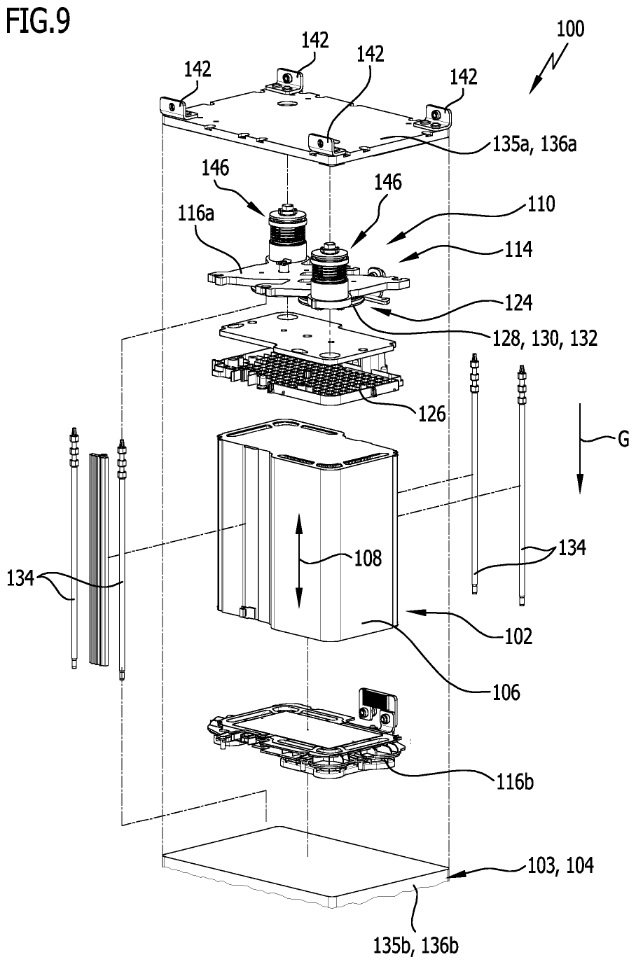

A fuel cell device shown schematically in FIGS. 1 to 9 and as a whole designated by 100 preferably comprises a fuel cell stack unit 102 and a supporting frame 103 which is preferably a housing 104 of the fuel cell device 100.

The fuel cell stack unit 102 is preferably arranged in the supporting frame 103, in particular in the housing 104.

The fuel cell stack unit 102 preferably comprises a fuel cell stack 106.

The fuel cell stack 106 preferably comprises a plurality of fuel cell elements 108 arranged in a stacking direction which are not shown separately and are also not identified separately with a reference numeral for reasons of clarity.

The fuel cell elements are in particular plate-shaped units which have different components for the electrochemical conversion of fuel, for conducting power and for conducting fluid.

It may be advantageous if the fuel cell device 100 comprises a bearing device 110, by means of which the fuel cell stack unit 102 is mounted in the supporting frame 103, in particular in the housing 104.

The fuel cell device 100 comprises in particular a fixed bearing device 112 and a floating bearing device 114.

The fuel cell stack unit 102 of the fuel cell device 100 preferably comprises two end plates 116, in particular an upper end plate 116a and a lower end plate 116b.

The upper end plate 116a and the lower end plate 116b are preferably arranged on end regions 118 of the fuel cell stack unit 102 which face away from one another.

The fixed bearing device 112 and the floating bearing device 114 are preferably arranged on the end regions 118 of the fuel cell stack unit 102 which face away from one another.

In an operating state of the fuel cell device 100, the upper end plate 116a is preferably arranged on an upper end region 118a of the fuel cell stack unit 102 in the direction of gravity G, wherein the lower end plate 116b is preferably arranged on a lower end region 118b of the fuel cell stack unit 102 in the direction of gravity G.

It may be advantageous if the fuel cell stack unit 102 further comprises a clamping device 120, wherein the fuel cell stack 106 is clamped between the two end plates 116a, 116b by means of the clamping device 120.

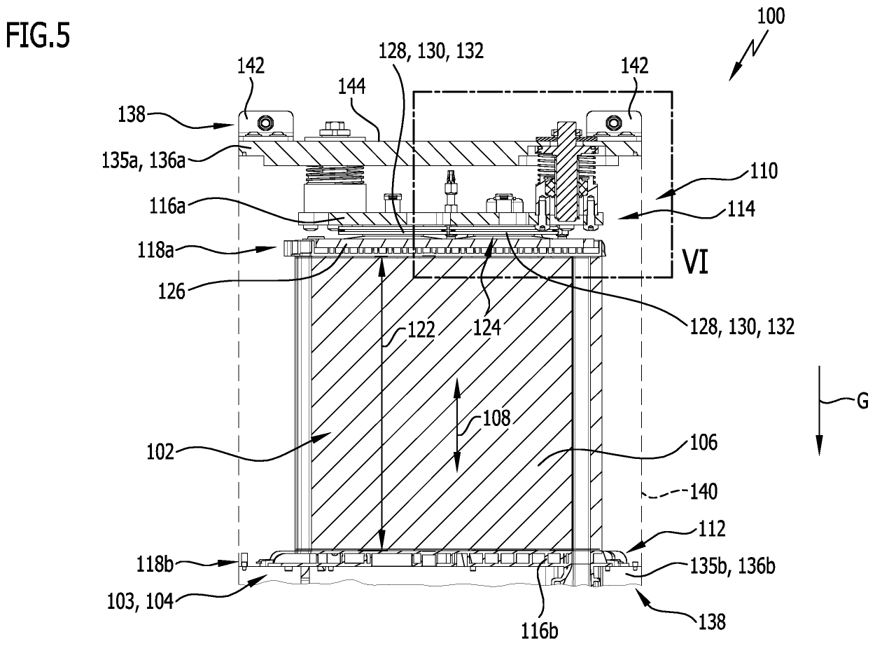

A height 122 of the fuel cell stack 106 (cf. FIG. 5) taken parallel to the stacking direction 108 of the fuel cell stack 106 is in particular subject to fluctuations, for example due to thermal expansion during operation of the fuel cell device 100 and/or due to a setting behavior of the fuel cell elements over a service life of the fuel cell device 100.

It may therefore be advantageous if the fuel cell stack unit 102 comprises a pressure equalization device 124.

The pressure equalization device 124 is used in particular to equalize changing compressive forces which can act on the fuel cell stack 106 due to the changing height 122 of the fuel cell stack 106, in particular for equalizing pressure forces acting in parallel with the stacking direction 108.

Preferably, on the one hand, the occurrence of excessively high pressure forces can be prevented with the pressure equalization device 124, wherein preferably on the other hand, excessively low pressure forces could be prevented which would lead to a leak of the fuel cell stack 108, since the fuel cell elements are not pressed against one another with sufficient pressure.

The fuel cell stack unit 102 preferably further comprises a pressure distributor plate 126.

It may be advantageous if the pressure equalization device 124 is arranged between the pressure distributor plate 126 and an end plate 116 of the fuel cell stack unit 102, for example between the pressure distributor plate 126 and the upper end plate 116a of the fuel cell stack unit 102.

Preferably, the fuel cell stack 106 is arranged directly between the lower end plate 116b and the pressure distributor plate 126.

The pressure equalization device 124 preferably comprises a plurality of spring elements 128.

For example, it is conceivable for the pressure equalization device 124 to comprise two disk spring assemblies 130, each comprising a plurality of disk spring elements 132.

The clamping device 120 of the fuel cell stack unit 102 preferably comprises a plurality of clamping elements 134, for example so-called “tie rods”.

The clamping elements 134 of the clamping device 120 are preferably arranged on the end plates 116 of the fuel cell stack unit 102 such that the end plates 116 of the fuel cell stack unit 102 are pulled toward one another and/or that a tensile force acts on the end plates 116 of the fuel cell stack unit 102 which pulls the end plates 116 toward one another.

The supporting frame 103 of the fuel cell device 100 preferably comprises an upper supporting frame element 135a and a lower supporting frame element 135b.

The upper supporting frame element 135a and the lower supporting frame element 135b are preferably fixed relative to each other.

In particular, a position of the upper supporting frame element 135a relative to a position of the lower supporting frame element 135b is fixed.

The housing 104 of the fuel cell device 100 preferably comprises an upper housing cover 136a and a lower housing cover 136b.

The upper supporting frame element 135a is therefore preferably an upper housing cover 136a, wherein the lower supporting frame element 135b is preferably a lower housing cover 136b.

The upper housing cover 136a and the lower housing cover 136b of the housing 104 are preferably arranged on end regions 138 of the housing 104 of the fuel cell device 100 which face away from one another.

In an operating state of the fuel cell device 100, the upper housing cover 136a is preferably arranged on an upper end region 138a of the fuel cell device 100 in the direction of gravity G, wherein the lower housing cover 136b is preferably arranged on a lower end region 138b of the fuel cell device 100 in the direction of gravity G.

It may be advantageous if the housing 104 also comprises a housing shell 140 which preferably connects the upper housing cover 136a and the lower housing cover 136b to one another.

The housing shell 140 is only schematically indicated in the figures.

An interior 141 of the housing 104 of the fuel cell device 100 is preferably delimited by the upper housing cover 136a, the housing shell 140 and the lower housing cover 136b.

The housing 104 of the fuel cell device 100 preferably comprises a plurality of mounting elements 142 which are fixed to the housing 104 on an outer side 144 of the housing 104.

For example, it is conceivable for the housing to comprise four mounting elements 142 which are fixed to the upper housing cover 136a and/or to the lower housing cover 136b of the housing 104.

The fuel cell device 100 can be fixed, for example, to a supporting structure of a vehicle, (not shown in the drawing) by means of the mounting elements 142.

The fixed bearing device 112 and the floating bearing device 114 are preferably arranged on sides of the fuel cell stack 106 of the fuel cell stack unit 102 which face away from one another.

The fuel cell stack unit 102 is preferably fixedly mounted on one side in the housing 104 of the fuel cell device 100 by means of the fixed bearing device 112.

The fuel cell stack unit 102 is preferably fixedly mounted at one of its end regions 118 in the housing 104 of the fuel cell device 100, for example on a housing cover 136 of the housing 104.

It may be advantageous, for example, if the lower end plate 116b of the fuel cell stack unit 102 is fixed to the lower housing cover 136b of the housing 104.

For example, it is conceivable for the lower end plate 116b of the fuel cell stack unit 102 to be screwed to the lower housing cover 136b of the housing 104.

Alternatively, it is conceivable for the lower end plate 116b of the fuel cell stack unit 102 to be integrally connected to the lower housing cover 136b of the housing 104.

In an embodiment of the fuel cell device 100 not shown in the drawings, the upper end plate 116a of the fuel cell stack unit 102 is fixed to the upper housing cover 136a of the housing 104.

The upper end plate 116a is, for example, screwed in one piece to the upper housing cover 136a of the housing 104 or, alternatively, is integrally connected to the upper housing cover 136a of the housing 104.

It may be advantageous if the fuel cell stack unit 102 is loosely mounted on one side in the housing 104 of the fuel cell device 100 by means of the floating bearing device 114.

The fuel cell stack unit 102 is preferably loosely mounted at one of its end regions 118 in the housing 104 of the fuel cell device 100, for example on a housing cover 136 of the housing.

If there is torsion of the fuel cell stack unit 102, in particular rotation of the upper end plate 116a relative to the lower end plate 116b can occur.

Such a rotation of the upper end plate 116a relative to the lower end plate 116b can cause the fuel cell elements of the fuel cell stack 106 to slide on one another, which can lead to destruction of the fuel cell stack 106.

The floating bearing device 114 is designed in particular such that the fuel cell stack unit 102 is mounted in the housing 104 of the fuel cell device 100 such that torsion of the fuel cell stack unit 102 can be limited and/or substantially prevented.

Preferably, the floating bearing device 114 is designed such that a rotation of the upper end plate 116a of the fuel cell stack unit 102 relative to the lower end plate 116b of the fuel cell stack unit 102 can be limited and/or substantially prevented.

The floating bearing device 114 preferably comprises a plurality of floating bearing units 146, for example two or more than two floating bearing units 146.

The floating bearing units 146 preferably each comprise two floating bearing elements 148, wherein a first floating bearing element 148a of the particular floating bearing unit 146 is preferably fixed to the fuel cell stack unit 102, and wherein a second floating bearing element 148b of the particular floating bearing unit 146 is preferably fixed to the housing 104 of the fuel cell device 100.

For example, it is conceivable for a first floating bearing element 148a of the particular floating bearing unit 146 to be fixed to an end plate 116 of the fuel cell stack unit 102, preferably to the upper end plate 116a.

It may also be advantageous if a second floating bearing element 148b of the particular floating bearing unit 146 is fixed to a housing cover 136 of the housing 104 of the fuel cell device 100, preferably to the upper housing cover 136a.

The floating bearing elements 148b of the floating bearing units 146, which elements are fixed to the housing 104, are preferably each guided in a floating bearing element 148a, which is fixed to the fuel cell stack unit 102, of a particular floating bearing unit 146 in a guide direction 150.

The floating bearing units 146 of the floating bearing device 114 preferably comprise or form a linear guide.

The guide direction 150 preferably extends in parallel with the stacking direction 108 of the fuel cell stack 106 of the fuel cell stack unit 102.

The floating bearing units 146 preferably each comprise a floating bearing element 148a which comprises a sleeve element 152.

In the embodiment of a fuel cell device 100 shown in the figures, this floating bearing element 148a is fixed in particular by means of a plurality of screw elements 154 to the upper end plate 116a of the fuel cell stack unit 102.

It may also be advantageous if the floating bearing units 146 further comprise a floating bearing element 148b which comprises or forms a rod element 156.

The floating bearing element 148b of the floating bearing units 146 preferably also comprises a flange portion 158 with which the floating bearing element 148b rests against the housing 104, in particular against the upper housing cover 136a.

For sealing between the housing 104, in particular the upper housing cover 136a and the floating bearing element 148b, the fuel cell device 100 can comprise a sealing element 159 which is arranged in a groove of the flange portion 158 of the floating bearing element 148b.

Preferably, the floating bearing element 148b of the floating bearing units 146 also comprises a fastening portion 160 which is guided through a passage opening 161 in the upper housing cover 136a in each case.

In this case, the floating bearing element 148b is screwed to the upper housing cover 136a preferably by means of a nut element 162.

In order to be able to align the floating bearing element 148b, the fastening portion 160 of the floating bearing element 148b can be displaced in the passage opening 161 in the upper housing cover 136a in the direction of the double arrow 163 during assembly of the fuel cell device 100.

The spring element 165 is preferably used only for mounting the fuel cell device 100.

The spring element 165 can preferably prevent the fastening portion 160 of the floating bearing element 148b from falling out of the passage opening 161 in the upper housing cover 136a in the direction of gravity G before the fastening portion 160 is screwed to the upper housing cover 136a by means of the nut element 162.

Preferably, the rod element 156 of a floating bearing element 148b, which is fixed to the housing 104 of the fuel cell device 100, is arranged at least partially in the sleeve element 152 of the floating bearing element 148a, which is fixed to the fuel cell stack unit 102.

The rod element 156 preferably projects at least partially into the sleeve element 152, in particular into an opening 164 of the sleeve element 152.

The floating bearing elements 148 of the floating bearing units 146 are preferably designed to be substantially rotationally symmetrical.

The floating bearing elements 148b fixed to the housing 104, which are guided in the floating bearing elements 148a fixed to the fuel cell stack unit 102, can preferably be moved in the guide direction 150 relative to the floating bearing element 148a fixed to the fuel cell stack unit 102.

The floating bearing elements 148 are preferably designed such that a movement of the floating bearing element 148b, which is fixed to the housing 104 and is guided in the floating bearing element 148a fixed to the fuel cell stack unit 102, is limited and/or prevented in a direction extending transversely, preferably perpendicularly, to the guide direction 150.

It may be advantageous if the floating bearing units 146 each comprise a floating bearing element 148a which comprises a compensating element 166.

The compensating element 166 is preferably arranged on, in particular fixed to, the floating bearing element 148a of the floating bearing unit 146, which element is fixed to the fuel cell stack unit 102.

The compensating element 166 is preferably fixed to the sleeve element 152 of the floating bearing element 148a.

For example, it is conceivable for the compensating element 166 to be inserted into the opening 164 of the sleeve element 152 and fixed there, for example, by means of a snap ring.

The compensating element 166 is preferably arranged in a direction extending transversely, preferably perpendicularly, to the guide direction 150 between the rod element 156 of the floating bearing element 148b fixed to the housing 104 and a sleeve element 152 of the floating bearing element 148a of a particular floating bearing unit 146, which floating bearing element is fixed to the fuel cell stack unit 102.

It may be advantageous if the compensating element 166 is a damping element 167.

The damping element 167 is preferably a rubber element 168, for example a rubber ring 170.

A damping element 167 designed as a rubber element 168 preferably comprises a metal sliding surface on which a rod element 156 can slide.

The damping element 167 preferably dampens and/or limits a movement of the two floating bearing elements 148a, 148b of a particular floating bearing unit 146 relative to one another in a direction extending transversely, preferably perpendicularly, to the guide direction 150.

The floating bearing elements 148a of the floating bearing units 146 are preferably arranged on the fuel cell stack unit 102, in particular fixed to the upper end plate 116a of the fuel cell stack unit 102, such that a distance between the floating bearing units 146 is maximum.

Preferably, a rotation of the upper end plate 116a of the fuel cell stack unit 102 relative to the lower end plate 116b can be prevented or limited even better by maximizing a distance of the floating bearing units 146 from one another.

It may be advantageous if the floating bearing elements 148b of the floating bearing units 146, which elements are fixed to the upper end plate 116a, are arranged diagonally opposite one another on the upper end plate 116a.

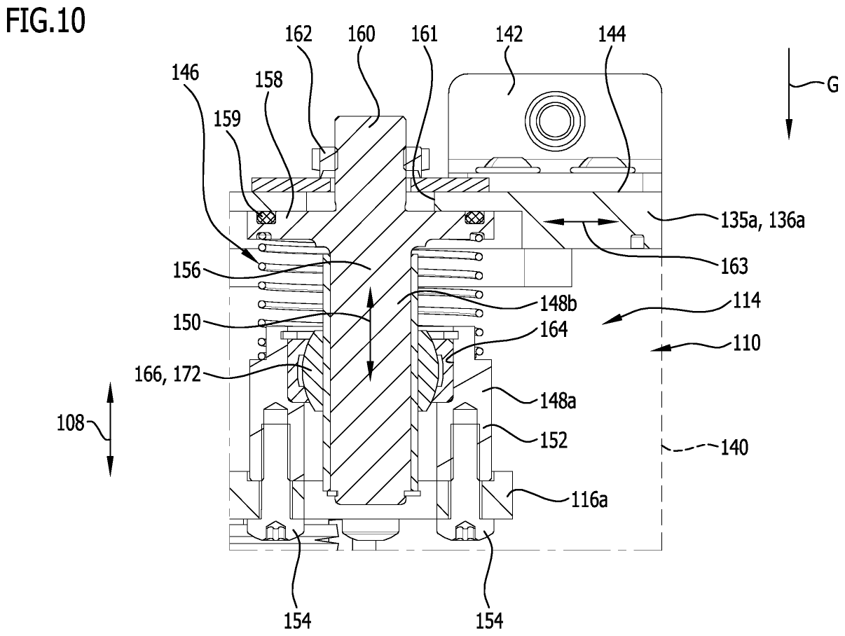

Another embodiment of a fuel cell device 100 shown in FIG. 10 substantially differs from the embodiment of a fuel cell device 100 shown in FIGS. 1 to 9 in that the compensating element 166 is formed by a pivot bearing 172.

By means of a compensating element 166 which is formed by a pivot bearing 172, angular compensation can preferably be made possible between the two floating bearing units (146) of the floating bearing device (114).

Otherwise, the embodiment of a fuel cell device 100 shown in FIG. 10 corresponds in terms of structure and function to the embodiment of a fuel cell device 100 shown in FIGS. 1 to 9, such that reference is made to the above description thereof.

Overall, a fuel cell device 100 can be provided which is easy and cost-effective to manufacture and which has improved durability.

1. A fuel cell device, wherein the fuel cell device comprises the following:
a fuel cell stack unit;
a supporting frame, in particular a housing, in which the fuel cell stack unit is arranged,
a bearing device, by means of which the fuel cell stack unit is mounted in the supporting frame, in particular in the housing,
wherein the fuel cell device comprises a fixed bearing device and a floating bearing device,
wherein the floating bearing device comprises one or more floating bearing units.

2. The fuel cell device according to claim 1, wherein the floating bearing device is designed such that the fuel cell stack unit is mounted in the supporting frame, in particular in the housing, of the fuel cell device such that torsion of the fuel cell stack unit can be limited and/or substantially prevented.

3. The fuel cell device according to claim 1, wherein the fuel cell stack unit is fixedly mounted on one side in the supporting frame, in particular in the housing, of the fuel cell device by means of the fixed bearing device.

4. The fuel cell device according to claim 1, wherein a lower end plate of the fuel cell stack unit is fixed to a supporting frame element, preferably to a housing cover, in particular to a lower supporting frame element, preferably to a lower housing cover.

5. The fuel cell device according to claim 1, wherein the fuel cell stack unit is loosely mounted on one side in the supporting frame, in particular in the housing, of the fuel cell device by means of the floating bearing device.

6. The fuel cell device according to claim 1, wherein a particular floating bearing unit comprises two floating bearing elements in each case, wherein a first floating bearing element of the particular floating bearing unit is preferably fixed to the fuel cell stack unit, and wherein a second floating bearing element of the particular floating bearing unit is preferably fixed to the supporting frame, in particular to the housing, of the fuel cell device.

7. The fuel cell device according to claim 6, wherein a first floating bearing element of the particular floating bearing unit is fixed to an end plate of the fuel cell stack unit and/or wherein a second floating bearing element of the particular floating bearing unit is fixed to a supporting frame element of the supporting frame, in particular to a housing cover of the housing, of the fuel cell device.

8. The fuel cell device according to claim 1, wherein a floating bearing element of a floating bearing unit, which element is fixed to the supporting frame, in particular to the housing, is guided in a guide direction in a floating bearing element of the floating bearing unit, which element is fixed to the fuel cell stack unit, and/or wherein a floating bearing element of a floating bearing unit, which element is fixed to the fuel cell stack unit, is guided in a guide direction in a floating bearing element of the floating bearing unit, which element is fixed to the supporting frame, in particular to the housing.

9. The fuel cell device according to claim 8, wherein the floating bearing element, which is fixed to the supporting frame, in particular to the housing, and is guided in the floating bearing element fixed to the fuel cell stack unit, can be moved in the guide direction relative to the floating bearing element fixed to the fuel cell stack unit, and/or wherein the floating bearing element, which is fixed to the fuel cell stack unit and is guided in the floating bearing element fixed to the supporting frame, in particular to the housing, can be moved in the guide direction relative to the floating bearing element fixed to the supporting frame, in particular to the housing.

10. The fuel cell device according to claim 8, wherein the floating bearing elements are designed such that a movement of the floating bearing element, which is fixed to the supporting frame, in particular to the housing, and is guided in the floating bearing element fixed to the fuel cell stack unit, is limited and/or prevented in a direction extending transversely, preferably perpendicularly, to the guide direction, and/or wherein the floating bearing elements are designed such that a movement of the floating bearing element, which is fixed to the fuel cell stack unit and is guided in the floating bearing element fixed to the supporting frame, in particular to the housing, is limited and/or prevented in a direction extending transversely, preferably perpendicularly, to the guide direction.

11. The fuel cell device according to claim 1, wherein a particular floating bearing unit comprises a floating bearing element which comprises a sleeve element, and in that the floating bearing unit further comprises a floating bearing element which comprises or forms a rod element, wherein the rod element is preferably arranged at least partially in the sleeve element.

12. The fuel cell device according to claim 1, wherein a particular floating bearing unit comprises a floating bearing element which comprises a compensating element that is arranged on, in particular fixed to, the floating bearing element of the floating bearing unit.

13. The fuel cell device according to claim 1, wherein the floating bearing device comprises two or more than two floating bearing units, wherein floating bearing elements of a particular floating bearing unit are preferably arranged on the fuel cell stack unit such that a distance between the floating bearing units is maximum.

14. The fuel cell device according to claim 1, wherein the floating bearing device comprises two floating bearing units, wherein floating bearing elements of the floating bearing units are arranged diagonally opposite one another on an end plate of the fuel cell stack unit.

15. The fuel cell device according to claim 1, wherein the floating bearing units of the floating bearing device comprise or form a linear guide.
